(19) United States
(12) Patent Application Publication
(10) Pub. No.: US 2007/0171092 A1
(43) Pub. Date: Jul. 26, 2007

(54) Automated meter reading system

(75) Inventor: Dee Allgood, Gambrills, MD (US)

Correspondence Address: DICKSTEIN SHAPIRO LLP, 1825 EYE STREET NW, Washington, DC, 20006-5403, US

(73) Assignee: MSI, LLC.

(21) Appl. No.: 11/326,390

(22) Filed: Jan. 6, 2006

(51) Int. Cl. G08C 15/06

(52) U.S. Cl. 340/870.02

(57) ABSTRACT

An automated meter reading system having an image obtaining device, mounted to the outside of a conventional meter, and a central station for receiving and processing images from the image obtaining device. The image obtaining device lies dormant until its internal circuitry recognizes that it is time to obtain an image of the meter's readout. Once the image is obtained, the image is transmitted to the central station, which processes the image to obtain billing and other information.

### FIELD OF THE INVENTION

The invention relates generally to meter reading devices and systems and more particularly to an automated meter reading device and system for processing meter information.

### BACKGROUND

Modern businesses and households are typically powered by electricity, gas and water. The electricity, gas and water are typically provided by an electric company, gas provider or water authority/commission, which are commonly referred to as public utilities.

The consumption of electricity, gas and water is measured by meters that have been installed at the customer's house or place of business. An electricity meter measures the amount of electricity, i.e., power, used by the customer and the consumption of electrical power is indicated by readings on the meter. FIG. 1 illustrates a typical electric utility meter 10. The meter 10 contains a display area 20 comprising dials 22, 24, 26, 28 indicating measured power consumption in e.g., kilowatt hours (kWh). Each dial 22, 24, 26, 28 has the numbers 0 through 9 and a pointer 22a, 24a, 26a, 28a that are respectively used for determining the value of the dial 22, 24, 26, 28. The display area 20 also comprises a multiplier 32, which indicates a multiplication factor (e.g., 10) that is applied to the value read from the dials 22, 24, 26, 28. Another dial 30, having a pointer 30a that rotates as power is being consumed, also appears in the display area 20.

The typical electric meter 10 contains a rotatable disc 40, which also rotates as power is being consumed, and an indicia area 42, which contains additional indicia (e.g., meter identification number, service information, etc.) related to the meter 10. The meter 10 is covered by a clear enclosure 12 to protect the internal workings of the meter 10 from the elements, while also allowing the display area 20 and indicia area 42 to be viewed.

FIGS. 2a and 2b illustrate face portions of typical gas meters 50, 70 used to measure the amount of gas consumed at a premises. The face of meter 50 comprises dials 52, 54, 56, 58 indicating measured gas consumption in e.g., cubic feet. Each dial 52, 54, 56, 58 has the numbers 0through 9 and a pointer 52a, 54a, 56a, 58a that are respectively used for determining the value of the dial 52, 54, 56, 58. As can be seen in FIG. 2a, dial 52 corresponds to the million's digit, dial 54 corresponds to the hundred thousand's digit, dial 56 corresponds to the ten thousand's digit and dial 58 corresponds to a thousand's digit. Two other dials 60, 62 are also present on the meter 50 face. Dial 60, having a pointer 60a that rotates as gas is being consumed, corresponds to a half foot of consumption while dial 62, having a pointer 62a that rotates as gas is being consumed, corresponds to two feet of gas consumption.

The face of meter 70 includes a digital readout 72 indicating measured gas consumption in e.g., cubic feet. A multiplier 74, which indicates a multiplication factor (e.g., 100) that is applied to the value read from the digital readout 72 is also provided. The meter 70 also includes two other dials 76, 78. Dial 76 which rotates as gas is being consumed, corresponds to a half foot of consumption while dial 78 which also rotates as gas is being consumed, corresponds to two feet of consumption. The meter 70 also includes an indicia area 80, where other information regarding the meter or customer's premises is displayed.

FIGS. 3a and 3b illustrate face portions of typical water meters 100, 120 used to measure the amount of water consumed at a premises. The face of meter 100 comprises dials 102, 104, 106, 108, 110 indicating measured water consumption typically in cubic feet. Each dial 102, 104, 106, 108, 110 has the numbers 0 through 9 and a pointer 102a, 104a, 106a, 108a, 110a that are respectively used for determining the value of the dial 102, 104, 106, 108, 110.

The face of meter 120 includes a digital readout 122 indicating total measured water consumption typically in cubic feet. Since water is typically billed out in 100 cubic foot intervals, the readout 122 contains a first portion 122a, which represents water consumption rounded down to the nearest 100-foot, and a second portion 122b, which represents the remaining water consumption (i.e., 0 to 99 cubic feet). A dial 124 is sometimes included, which rotates between a scale of 0 to 0.9 as water is being consumed, to indicate that water is currently being consumed. Although not shown, water meters sometimes include leak detectors.

In order to bill the consumer, it is necessary for the utility to obtain a reading from the appropriate meter (i.e., power utility needs to read an electric meter 10, gas provider needs to read meter 50 or 70, water authority needs to read meter 100, 120). Since the meter is located at the household or place of business, an employee from the utility/service provider must physically visit the house/business to take the readings from the meter. Therefore, before the utility can issue bills to its customers, the meters at each house or business must be manually read. It will be appreciated that this represents a significant expenditure of manual effort. The situation is further exacerbated by the inaccessibility of some meters (e.g., located inside the basement of the house or business), and the unavailability for reading during normal working hours when the occupants are at work.

Accordingly, there have been efforts to modify the manner in which meter readings are obtained. For example, some companies have gone to great expense to design special hardware attachments and/or meter inserts so that they may obtain pulses from the various meters. The obtained pulsed data is then translated to meter data and sent to an office where billing information can be obtained from the data. Oftentimes, however, the obtained meter data is out of synch with the meter's actual readout, which leads to incorrect readings and billing. This is usually caused when the electronic reading does not match the meter mechanical reading.

Another problem is that these pulse obtaining devices must be continuously powered to ensure that they do not miss any pulses from the meter. Thus, the devices use a lot of energy and need a constant source of power to remain operational. Any battery powered pulse obtaining devices will run down their batteries rather quickly since the devices are continuously in operation. Moreover, these devices are costly to develop and manufacture. The pulse devices can add as much as $100.00 to the meter's cost. Yet another problem is that, in some cases the utilities do not wish to have pulse output devices added to their meters. Sometimes the utilities charge a rather large premium to add a pulse output to their meter, which is undesirable. It is also undesirable to have to modify the electronics of the meter to accommodate the pulse obtaining device.

U.S. Pat. No. 5,016,025 discloses an automatic secured document reading apparatus for a meter. The apparatus includes a mount for holding an instant-picture camera at a distance away from a meter, a clock, that is positioned between the meter and the camera, and a compartment which is placed adjacent the camera. To be vandal proof, an enclosure is built around the apparatus and the meter. A timer triggers the camera to take a photograph of the meter and the clock. The photograph falls into the compartment, where the photograph can be subsequently collected by authorized personnel. The apparatus, however, requires a complex and bulky mount, compartment and enclosure, and still requires personnel to go to the meter to obtain the photographed meter reading. As such, the apparatus, among other things, does not alleviate the problems associated with using personnel to read the meter.

U.S. Pat. No. 4,811,011 discloses a utility meter reading and monitoring system that mounts an image scanner on the inside of a meter's cover. The scanner continuously scans images of the meter's readout and transfers the images to a microcomputer also at the customer's premises. The microcomputer continuously monitors the readings and converts the images into meter data. A communications interface connected to the microcomputer is used to communicate with a central office main computer that polls the microcomputers at each customer premises and accepts the meter data to obtain billing and local management information. Due to the continuous scanning, monitoring and transferring of meter images, the system must be continuously powered and active. The system also requires image acquisition and processing circuitry at the customer's premises, which is also undesirable.

U.S. Patent Application Publication 2004/0078350 discloses a meter reading system that uses a meter unit having two power supplies to obtain an image of a meter, extract meter data from the image and then transmit the meter data to a receiver; the receiver transfers the data to a computer for further processing. In the meter unit, a clock having a calendar function activates a first power supply, which is used to power a radio communication system. Once powered, the radio communications system is used to receive a read command signal transmitted from another device transmitting at the appropriate frequency. When the read command signal is received, the meter unit main power supply is activated. The main power supply powers an image inputting system (having an image acquisition unit and a pattern recognition unit) and a central processing unit such that an image of a meter is input and processed at the meter unit. The pattern recognition unit extracts the value shown on the meter and transmits the extracted value to a receiver through the radio communication system.

The receiver of the meter data is an automobile receiving unit or a hand held unit, both of which require utility personnel to make rounds to read the meter. As such, the system does not alleviate the problems associated with using personnel to read the meter. In addition, because the meter unit performs image acquisition and recognition, and must also activate a communication system to look for and receive a read command signal, the meter unit requires two power supplies and additional logic for coordinating the powering up of the image acquisition and recognition units.

U.S. Patent Application Publication 2004/0032504 discloses a handheld apparatus for obtaining information from a utility meter. The handheld device includes a digital camera that, when activated by the operator, takes a digital image of the utility meter. The digital image is input into a computer, which extracts the information displayed on the meter from the image. An operator is required to make rounds to read the meter. As such, the handheld device is not automated and does not, among other things, alleviate the problems associated with using personnel to read the meter.

U.S. Pat. No. 5,870,140 discloses a remote meter viewing and reporting system. The system includes a remote camera located at the meter and a central computer that communicates with the camera through a telephone modem. The remote unit is powered by the electrical supply of the meter or an auxiliary power supply. In response to a command from the central computer, the camera scans the meter face and stores an image of the face in a local memory. The scanned image is transmitted to the central computer through the modem. The central computer analyzes the scanned image to obtain the current readings on the dials. The processed image is used to generate a billing statement. The remote unit, however, is activated by the central computer, which means that the remote unit's controller, communications modem and interface must be continuously powered and active to ensure that the command from the central computer is received, which is undesirable.

As can be seen, although there have been advancements in meter reading technology, there remains shortcomings that still need to be addressed. Thus, it is desirable to provide an automated meter reading system that can be used with a conventional meter and does not require modifications to the electrical or mechanical workings of the meter. It is also desirable that the system uses a self-powered, fully automated meter readout image obtaining and sending device that conserves power by lying dormant until its internal circuitry recognizes that it is time to obtain an image of the associated meter's readout. It is further desired that the image obtaining device performs no image or other complex processing, simplifying the components of the image obtaining device, and merely obtains and transfers images to a central station without the prompting of the central station or another external device.

### SUMMARY

The invention provides an automated meter reading system that can be used with a conventional meter and does not require modifications to the electrical or mechanical workings of the meter.

The invention also provides an automated meter reading system that uses a self-powered, fully automated meter readout image obtaining and sending device that conserves power by lying dormant until its internal circuitry recognizes that it is time to obtain an image of the associated meter's readout.

The invention further provides an automated meter reading system having an image obtaining device that performs no image or other complex processing.

The above and other features and advantages are achieved in various exemplary embodiments of the invention by providing an automated meter reading system having an image obtaining device, mounted to the outside of a conventional meter, and a central station for receiving and processing images from the image obtaining device. The image obtaining device lies dormant until its internal circuitry recognizes that it is time to obtain an image of the meter's readout. Once the image is obtained, the image is transmitted to the central station, which processes the image to obtain billing and other information.

The invention may transmit the images using wired or wireless technology (e.g., wireless Internet, satellite, RF). The images may be automatically obtained on a periodic basis (e.g., once a month) using a simple wide angle camera mounted to the outside of the meter. Thus, the invention eliminates the need to change any electrical or mechanical components in the existing meter and makes its installation quick, unobtrusive and inexpensive.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a typical electric utility meter used to measure the amount of power consumed at a premises;

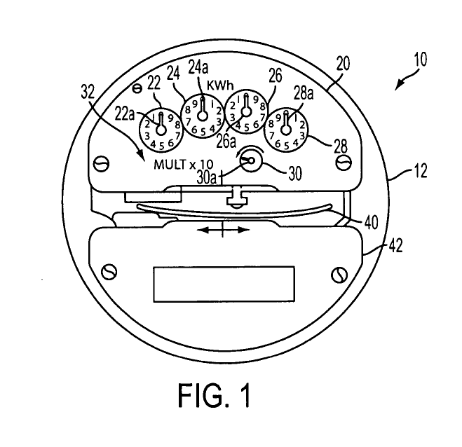

FIGS. 2a and 2b illustrate face portions of typical gas meters used to measure the amount of gas consumed at a premises;

FIGS. 3a and 3b illustrate face portions of typical water meters used to measure the amount of water consumed at a premises;

FIG. 4 is a top down view of meter having an automated meter image obtaining and sending device according to an exemplary embodiment of the invention;

FIG. 5 is a front view of a meter having the automated meter image obtaining and sending device according to an exemplary embodiment of the invention;

FIG. 6 illustrates an automated meter reading system according to an exemplary embodiment of the invention;

FIGS. 7A and 7B illustrate a mounting system for an automated meter image obtaining and sending device according to other exemplary embodiments of the invention; and

FIG. 8 illustrates an automated meter reading system according to another exemplary embodiment of the invention.

### DETAILED DESCRIPTION

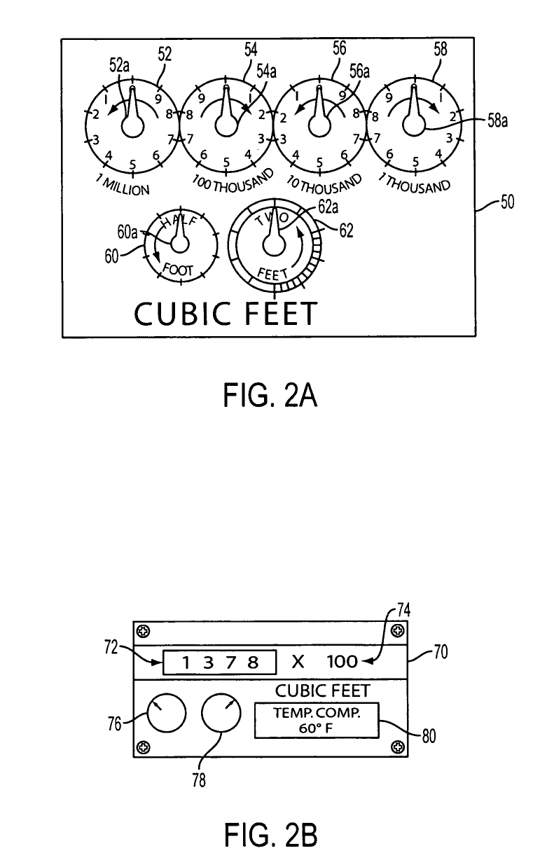

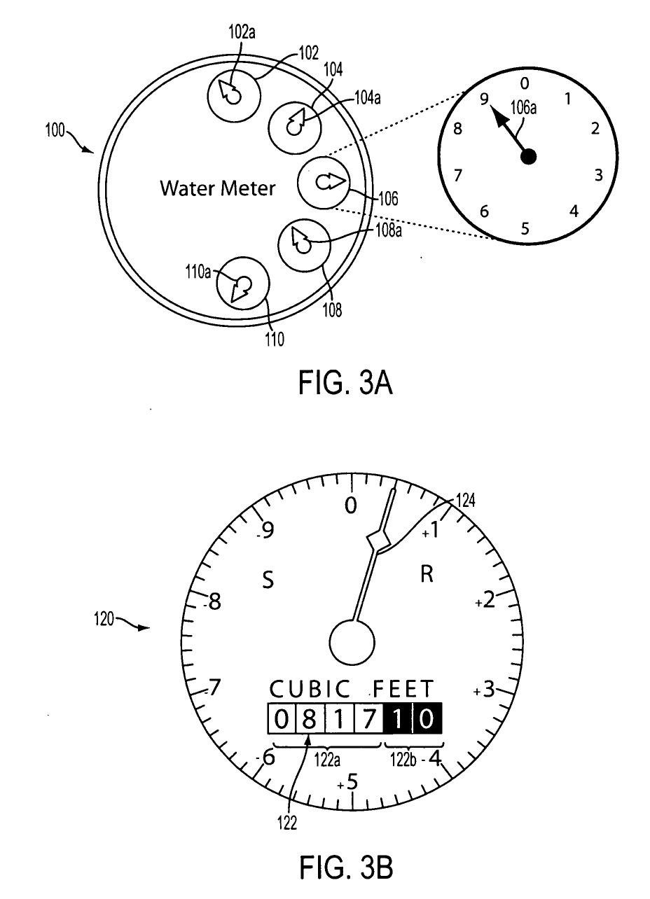

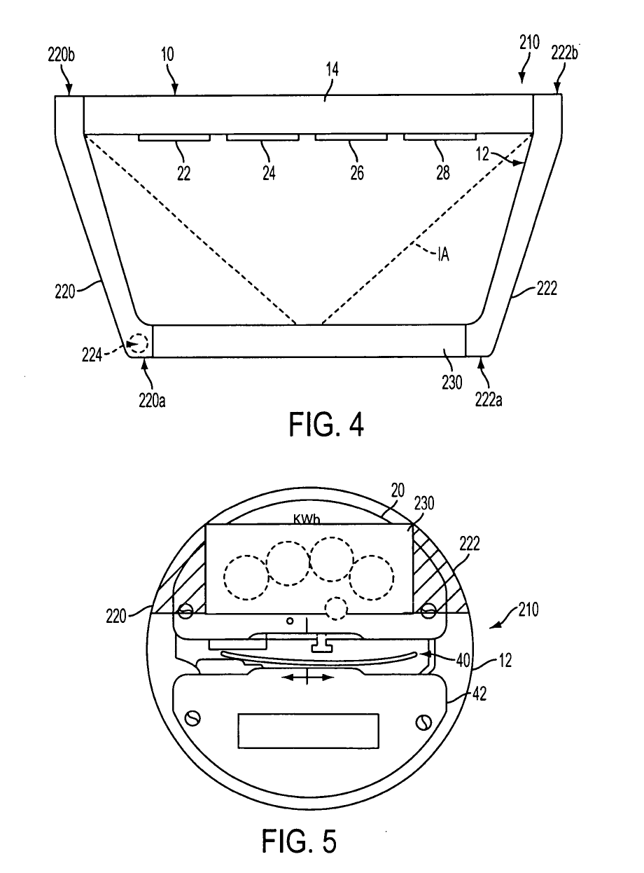

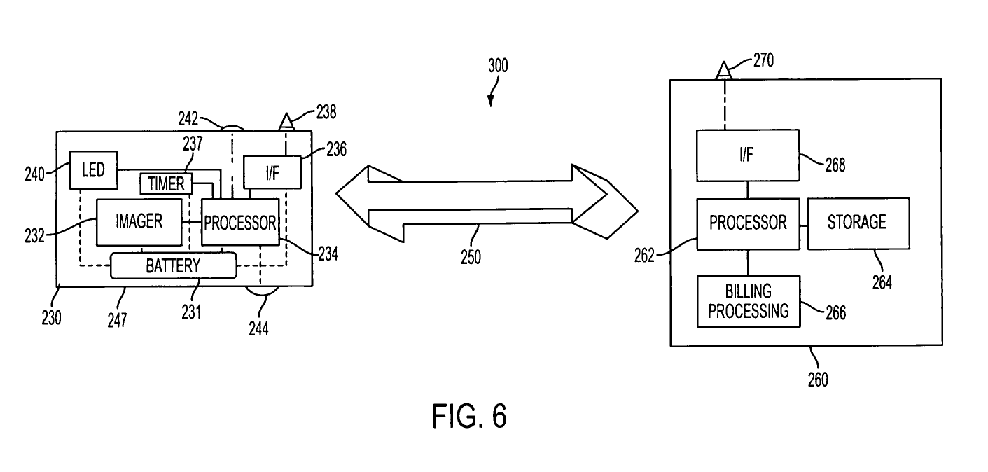

FIGS. 4 and 5 illustrate a modified meter 210 having an automated meter image obtaining and sending device 230 constructed according to an exemplary embodiment of the invention. The image obtaining and sending device 230 is mounted to a conventional meter 10 by mounting hardware 220, 222. Although FIGS. 4 and 5 illustrate an electric utility meter 10, it should be appreciated that the image obtaining and sending device 230, and the invention, can be used with gas meters 50 (FIG. 2a), 70 (FIG. 2b), water meters 100 (FIG. 3a), 120 (FIG. 3b) and other types of meters or displays requiring periodic readout and analysis. It should also be appreciated that meters having digital readouts (e.g., meter 70 of FIG. 2b, meter 120 of FIG. 3b) can also be used with the invention.

In one embodiment of the invention, first end portions 220a, 222a of the mounts 220, 222 hold the image obtaining and sending device 230 on the outside of the clear meter enclosure 12 in front of the meter display area 20. Second end portions 220b, 222b of the mounts 220, 222 may be attached to the base 14 of the meter 10. As such, in the illustrated embodiment, device 230 is permanently mounted to the outside of the meter 10. In another embodiment, the first mount 220 includes a hinge 224 such that the image obtaining and sending device 230 can be rotated away from the meter enclosure 12 to provide a clear view of the entire display area 20 if desired.

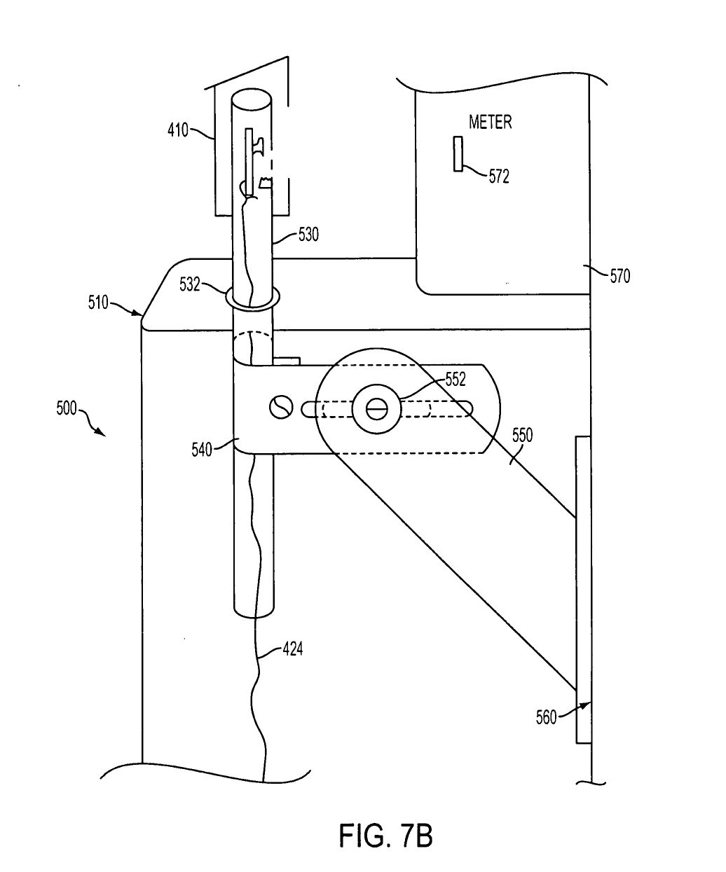

FIG. 7A illustrates a mounting device 400 for the automated meter image obtaining and sending device according to another embodiment of the invention. The device 400 comprises a shield portion 410 attached to a first tube 430, which can be connected to another tube 450 via a clamp 440. The tubing is connectable to a meter base by a base portion 456, which contains an adjustable clamp 452 for positioning the tubing. The illustrated shield portion 410, shown in the exploded view, includes a rain and sun shield 412 for the shielding the camera's lens, and a pin-sized hole 414 for the lens. It should be appreciated, however, that a glass or plastic lens may be used instead of the pin-size hole 414 lens. An imager 416 and an LED 420 are mounted to a printed circuit or printed wiring board 418. A separate LED shield 422 may also be included. The tubing and commercial piping 424 can be used to route any cables 424 necessary at the installation site.

FIG. 7B illustrates a mounting device 500 for the automated meter image obtaining and sending device according to another embodiment of the invention. The device 500 comprises a shield portion 410 attached to a tube 530 and a housing 510. The shield portion 410 maybe the same shield portion illustrated in FIG. 7A. The tube 530 is routed through the housing 510 and connected to a mounting bracket 550 via mounting hardware 540 attached to the tube 530. An o-ring 532 or other sealing mechanism may be used to ensure that environmental elements do not enter or adversely impact the components inside the housing 510. The bracket 550 contains an adjustable clamp 552 for positioning the tubing 530. The bracket 550 is connectable to a meter base or wall 560. The tubing 530 is commercial piping and can be used to route any cables 424 necessary at the installation site. As can be seen in FIG. 7B, the mounting device 500 holds the shield portion 410 in front of a meter 570 and the meter readout 570.

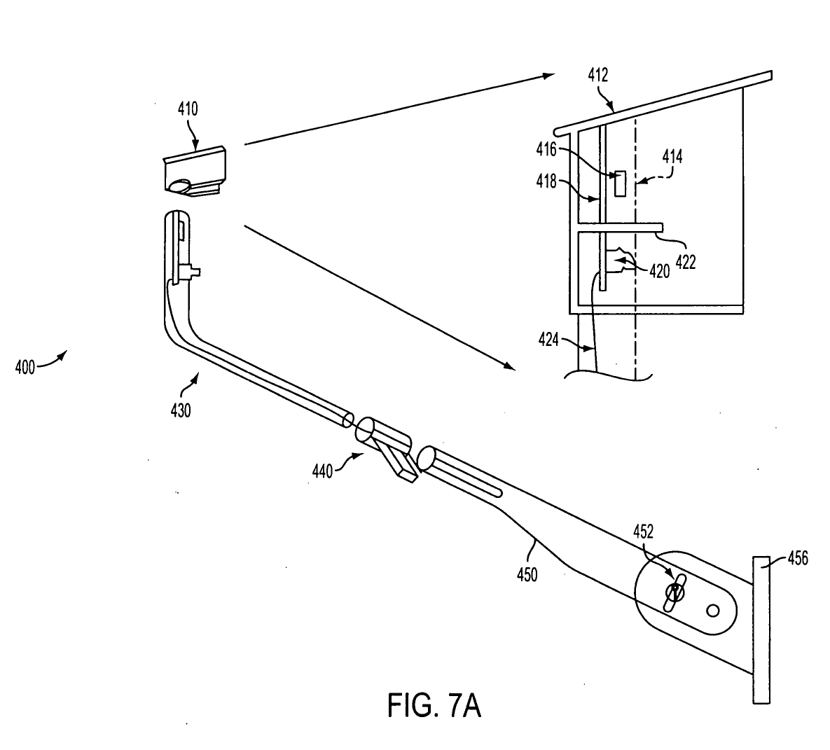

Referring again to FIGS. 4 and 5, the image obtaining and sending device 230 contains a wide angle imager/camera (discussed below with reference to FIG. 6) having an image obtaining area IA that is wide enough to obtain an image of the meter readout dials 22, 24, 26, 28. It should be noted that the image obtaining and sending device 230 does not have to be mounted directly in front of the display are 20 as long as the image obtaining area IA can obtain an image of the dials 22, 24, 26, 28 (or digital readout).

FIG. 6 illustrates an automated meter reading system 300 according to an exemplary embodiment of the invention. The system comprises at least one image obtaining and sending device 230 and a central station 260. It should be appreciated that any number of image obtaining and sending devices 230 may be used to practice the invention. Moreover, it should be appreciated that there can be more than one central station 260 if desired. The image obtaining and sending device 230 communicates with the central station 260 via a communication link 250, which can be a known wired communication link or any wireless communication link (e.g., wireless internet, RF, satellite, etc.). In a preferred embodiment, wireless Internet communications (i.e., 802.11 and 802.15.4) are used as the communication mechanism in the system 300.

The image obtaining and sending device 230 includes an imager 232, processor 234, communication interface 236, timer 237 and a battery 231 within a housing 247. The imager 232 can be a conventional imager such as a CMOS imager or a CCD imager. The device 230 may also include a light emitting diode (LED) 240 contained within a wall of the housing 247, which can serve as a flash for the device 230. It should be appreciated that any other light source may be used as a flash and that the invention is not limited to LEDs. The imager 232 communicates with the processor 234. In one embodiment of the invention, the imager 232 and the processor 234 are contained on the same integrated circuit. The processor 234 communicates with the interface 236, timer 237 and the LED 240. The battery 231 provides power to the components of the device 230.

If desired, an antenna 238 may be mounted to the housing 247 and connected to the interface 236 to bolster wireless communications (if used). The device 230 may also include a power/reset button 244 and a shutter 242, both of which are connected to the processor 234.

In the illustrated embodiment, the central station 260 includes a processor 262, storage medium 264 and a communication interface 268. If desired, the central location 260 may include a billing processing component 266, which may be separate from or part of the processor 262. In addition, the central station 260 may include an antenna 270 that communicates with the interface 268 to bolster wireless communications. The central station 260 may include as many communication interfaces that are required to communicate with and receive images from the various image obtaining and sending devices 230 implemented in the system. That is, if the system 300 uses image obtaining and sending devices 230 that utilize wired communications, the central station 260 will include a wired interface (e.g., modem, DSL). If the system 300 uses different wireless communication links (e.g., wireless internet or network, RF, satellite), then the central station 260 will include the appropriate interfaces.

In operation, the image obtaining and sending device 230 remains in a power-down/dormant state. Only the timer 237 is operational and drawing power from the battery 231. When the timer 237 expires, a signal is sent to the processor 234 to wake up the processor 234. The processor 234 activates the imager 232 causing it to obtain an image of the meter display area readout. If desired, the processor 234 can activate the LED 240 such that it flashes light as the image is being obtained. Thus, the image obtaining and sending device 230 obtains an image of the meter display area (using the imager 232 as controlled by the processor 234) and then sends the image along with the device's 230 unique address to the central station 260 (using the processor 234, interface 236, and if a wireless communication is being used, the antenna 238).

The central station 260 receives the image and address (using the antenna 270 (if a wireless communication is being received), interface 268 and processor 262). The central station 260 performs a pattern recognition or optical character recognition (OCR) process on the image to obtain the meter readout information. The meter readout information and unique address associated with the image obtaining and sending device 230 are then used by the processor 262 and/or billing processing 266 to calculate a bill or perform other desired processing. The image or meter data may be stored in the storage medium 264 for further processing.

In a preferred embodiment, the unique address is associated with the device 230 itself, which is coordinated with the address of the premises back at the central station 260. This can be coordinated as the devices 230 are being installed. It should be appreciated, however, that in another embodiment the address can be read from an indicator/address displayed on the meter and thus, be part of the image sent to the central station.

In one embodiment, the processor 234 resets the timer 237 and shuts itself down. The processor 234 serves as a controller for the device 230. The processor 234 can be programmed to reset the timer 237 such that the timer 237 expires at a desired billing rate (i.e., once a month). In another embodiment of the invention, the central station 260 may send a response to the image obtaining and sending device 230 after the image data has been received. The response may include a message telling the device 230 to send another image in the future and after a specified time has elapsed. The processor 234 of the image obtaining and sending device 230 will set the timer 237 based on the response.

Regardless of how the timer 237 is set, the image obtaining and sending device 230 of the invention is truly automated. Personnel are not required to initiate the meter reading, processing and rescheduling of the next reading. Personnel are not required to visit the meter once the device 230 is installed unless the utility desires such a visit. When personnel are dispatched to the premises, the shutter 242 and/or power/reset button 244 may be depressed to activate the device 230 and cause it to take and transmit an image.

Another improvement over other meter reading systems is that the device 230 of the invention is not waiting for a signal from the central station 260 prior to obtaining the image. The device 230 is shutdown for substantially most of the time. It is estimated that the device 230 will only be activated for a few seconds a billing period. Thus, the device 230 is not continuously looking for a signal from the central station, nor is it continuously monitoring the meter readout. Thus, there is very little power consumed by the device 230.

It should be appreciated that the setting of the timer 237 may not always be periodic and may be variable depending on the needs of the central station 260. In addition, the message from the central station may simply cause the image obtaining and sending device 230 to go to sleep for a predetermined time and once the time expires, cause the device 230 to send a message saying “I am awake and I am waiting for further instructions.” The central station 260 may then send further instructions to the device 230. In this embodiment, the central station 260 will determine what action to take and when to take it.

In most cases the action will be to send another image in e.g., 30 days. However, there are many scenarios where the image may need to be sent at an earlier time. For example, if the central station 260 knows that a certain tenant is moving in or out on a specified date, the device 230 will be alerted to send an image on that date. In addition, if analysis of the image cannot be properly made (e.g., the image may show water vapor on the camera lens, which may adversely impact the analysis), the timer 237 may be reset to expire within a few hours so that a new image may be obtained in the same billing period.

It should be noted that the device 230 does not need a true calendar capability, it only needs the ability to sense passage of time. A simple timer 237 will run for more than 20 years on a AA lithium battery. Since the device 230 will typically be active for only a few seconds each month, achieving a battery life in excess of 5 years is very easy, even with a small inexpensive battery 231, something the prior meter systems cannot achieve.

It should be noted that the image obtaining and sending device 230 of the invention contains little processing (other than the processing required to communicate with the central station 260, set the timer 237, obtain an image and transmit it along with the unique address) and no image recognition or OCR capabilities, which simplifies the device 230, keeps cost down and consumes less power than prior automated meter systems.

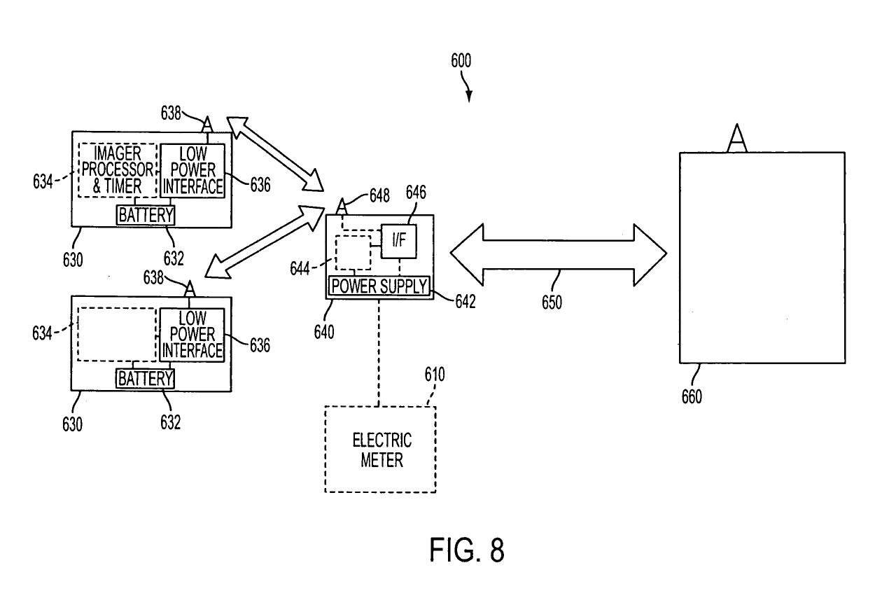

In many situations, there will be multiple utility/service provider meters at any given site (e.g., an electricity meter and a water meter). In some cases there will be an electric meter, water meter and gas or oil meter at the same location. FIG. 8 illustrates a system 600 according to another embodiment of the invention in which multiple image obtaining and sending devices 630, 640 are located at a customer's premises. In a desired embodiment, water, gas and/or oil meters (i.e., non-electric meters) will be read with battery powered image obtaining and sending devices 630. For electric meters, on the other hand, image obtaining and sending devices 640 will have a power source 642 that taps into the electric meter 610 or an electrical connection to and/or nearby the meter. As such, for device 640, electrical power is readily available and battery life is not an issue. It should be appreciated, however, that device 640 could also be the same as device 230, slightly modified as discussed below, if desired.

The battery powered image obtaining and sending devices 630, in a desired embodiment, will send their meter readout images to the electric powered image obtaining and sending device 640. Devices 630 are essentially the same as device 230 (described above). That is, the devices 630 contain imager, timer, processor circuitry 634 for obtaining meter readout images and transmitting them over an interface 636 and through antenna 638 (as described above). In the illustrated embodiment, however, devices 630 may use a low power interface 636 since it is desired that they only transmit the images to device 640. This means that devices 630 will be less expensive, and use less power, than device 230.

Image obtaining and sending device 640 will contain circuitry 644 for obtaining an image and communicating with devices 630 and central station 660 (which may be the same or similar as central station 260 described above). With the advances in processor design and simple and fast character recognition software, it is desired that device 640 analyze (e.g., OCR, pattern recognition, etc.) its obtained images and the obtained images of devices 230, and only send reading information to the central station 660 (as opposed to the images themselves) using interface 646, antenna 648 and communication medium 650. Thus, even if the OCR capability is added to device 640, the device 640 will still be less costly than prior art systems previously discussed. It should be appreciated that device 640 does not have to perform the image analysis function, leaving that function to the central station (as discussed in detail above).

The illustrated embodiment has the added benefit that the time required to synchronize and be recognized by the central station will not be spent by a battery powered image obtaining and sending device 630. Thus, conserving even more power. The electrical image obtaining and sending device 640 may also include a battery to insure that there will be no loss of data and to insure proper operation in case of a power outage.

In a desired embodiment, the automated meter image obtaining and sending device (e.g., device 230 or 630) includes an antenna that is mounted to and directly connected to the transmitting interface of the device. However, some meter locations are not suitable for sending data via an RF signal. Some prior art devices use cabling between the transmitting interface and antenna to overcome this problem. The RF cable allows the antenna to be moved away from the metering device to a location suitable for RF transmission. Unfortunately, the cabling causes RF loss that must be compensated for - the compensation for RF loss causes these prior art devices to be more expensive and use significantly more power. Accordingly, in a desired embodiment, the RF transmitter including the antenna can be easily separated from the automated meter image obtaining and sending device connected by a cable carrying digital signals and power. In this scenario the cable losses are insignificant and placement of the antenna to obtain an optimum RF signal path is accomplished without the need of increasing power consumption.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. An automated meter reading device comprising:
an imaging device;
a timer, said timer generating a first signal when a predetermined time expires;
a controller being activated by the first signal and causing the imaging device to obtain an image of a display area of the meter, said controller inputting the image from said imaging device; and
a communication interface for transmitting the image to an external device.

2. The meter reading device of claim 1,wherein said meter reading device is powered by a battery.

3. The meter reading device of claim 1, further comprising a light emitting diode, said light emitting diode being activated by the controller when the image is being obtained.

4. The meter reading device of claim 1, wherein said meter reading device is mounted to an outside of the meter.

5. The meter reading device of claim 1, wherein said controller resets said timer and enters a power down mode after the image is transmitted.

6. The meter reading device of claim 5, wherein said controller resets said timer based on a command from the external device.

7. The meter reading device of claim 1, wherein said imaging device is one of a CMOS imager and CCD imager.

8. The meter reading device of claim 1, wherein said controller comprises a processor and said imaging device and processor are contained on the same integrated circuit.

9. The meter reading device of claim 1, wherein the communication interface comprises means for wireless communications.

10. The meter reading device of claim 9, wherein said wireless communications means comprises a wireless Internet communication network.

11. The meter reading device of claim 9, wherein said wireless communications means comprises satellite communications.

12. The meter reading device of claim 9, wherein said wireless communications means comprises radio frequency communications.

13. The meter reading device of claim 1, wherein the communication interface comprises a wired communication.

14. The meter reading device of claim 1, further comprising an antenna directly connected to said communication interface, wherein a transmitter portion of said communication interface and said antenna are separable from said meter reading device.

15. An automated meter reading device comprising:
a housing;
a mount for mounting said housing to a meter;
a timer within said housing, said timer generating a first signal when a predetermined time expires;
a controller within said housing being activated by the first signal and causing the imaging device to obtain an image of a display area of the meter, said controller inputting the image from said imaging device; and
a communication interface within said housing for transmitting the image to an external device.

16. The meter reading device of claim 15, further comprising a light emitting diode within a wall of said housing, said light emitting diode being activated by the controller when the image is being obtained.

17. The meter reading device of claim 15, wherein said controller resets said timer and enters a power down mode after the image is transmitted.

18. The meter reading device of claim 17, wherein said controller resets said timer based on a command from the external device.

19. The meter reading device of claim 15, wherein the communication interface comprises means for wireless communications.

20. The meter reading device of claim 15, wherein the communication interface comprises a wired communication.

21. An automated meter reading system comprising:
an automated image obtaining and sending device comprising:
a housing,
a mount for mounting said housing to a meter,
a timer within said housing, said timer generating a first signal when a predetermined time expires,
a first processor within said housing being activated by the first signal and causing the imaging device to obtain an image of a display area of the meter, said first processor inputting the image from said imaging device, and
a first communication interface within said housing for transmitting the image; and
a central station comprising:
a second communication interface for receiving the transmitted image from the first communication interface, and
a second processor for recognizing a pattern in the image and using the pattern to determine a value of the meter display area.

22. The system of claim 21, wherein said automated image obtaining and sending device further comprises a light emitting diode within a wall of said housing, said light emitting diode being activated by the controller when the image is being obtained.

23. The system of claim 21, wherein said first processor resets said timer and enters a power down mode after the image is transmitted.

24. The system of claim 23, wherein said first processor resets said timer based on a command from the central station.

25. The system of claim 21, wherein said automated image obtaining and sending device communicates with said central station using a wireless network.

26. The system of claim 21, wherein said central station further extracts an address associated with said automated image obtaining and sending device and uses the address and meter display area value to generate a bill for a metered utility.

27. The system of claim 21, wherein said central station further comprises a storage medium for storing the value and image.

28. The system of claim 21, wherein said central station sends a command to said automated image obtaining and sending device to reset the timer.

29. The system of claim 21, wherein said automated image obtaining and sending device comprises a shutter for obtaining an image of the display area.

30. An automated meter reading system comprising:
a plurality of automated image obtaining and sending devices, each device comprising an imaging device, a timer, said timer generating a first signal when a predetermined time expires, a controller being activated by the first signal and causing the imaging device to obtain an image of a display area of the meter, said controller inputting the image from said imaging device, and a communication interface for transmitting the image via a wireless communication medium,
wherein at least one of the automated image obtaining and sending devices transmits its associated image to another of said automated image obtaining and sending devices and said another automated image obtaining and sending device transmits its images and images received from said at least one automated image obtaining and sending device to an external device.

31. An automated meter reading system comprising:
a plurality of automated image obtaining and sending devices, each device comprising an imaging device, a timer, said timer generating a first signal when a predetermined time expires, a controller being activated by the first signal and causing the imaging device to obtain an image of a display area of the meter, said controller inputting the image from said imaging device, and a communication interface for transmitting the image via a wireless communication medium,
wherein at least one of the automated image obtaining and sending devices transmits its associated image to another of said automated image obtaining and sending devices and said another automated image obtaining and sending device processes its images and images received from said at least one automated image obtaining and sending device and transmits data representing said images to an external device.
